(19) United States
(12) Patent Application Publication
(10) Pub. No.: US 2005/0143979 A1
(43) Pub. Date: Jun. 30, 2005

(54) Variable-frame speech coding/decoding apparatus and method

(76) Inventors: Mi Suk Lee, Daejeon-city (KR); Do Young Kim, Daejeon-city (KR); Jongmo Sung, Daejeon-city (KR); Hyun Woo Kim, Seoul (KR); Hong Goo Kang, Seoul (KR); Sung Kyo Jung, Seoul (KR); Dae Hee Youn, Daejeon-city (KR); Hong Kook Kim, Kyungki-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/006,447

(22) Filed: Dec. 6, 2004

(30) Foreign Application Priority Data
Dec. 26, 2003 (KR) 2003-97150
Nov. 26, 2004 (KR) 2004-97916

(51) Int. Cl. G10L 11/06

(52) U.S. Cl. 704/208

(57) ABSTRACT

There is provided a speech coding/decoding apparatus and method, in which the input speech signals are classified into several classes in accordance with characteristics of the input speech signals and the input speech signals are coded using frame sizes, quantizer structures, and bit assignment methods corresponding to the determined classes, or in which the frame sizes can be adjusted in accordance with network conditions or codec type of a counter part. Therefore, by optimally adjusting the frame size, the quantizer structure, and the bit assignment method in accordance with the characteristics of input speech, it is possible to improve the performance of the speech coding apparatus, and by adjusting the frame size in accordance with the speech codec type of a counter part, it is also possible to reduce the total end-to-end delay.

This application claims the priority of Korean Patent Application Nos. 2003-97150, filed on Dec. 26, 2003, and 2004-97916, filed on 26 Nov. 2004 in the Korean Intellectual Property Office, the disclosures of which are incorporated herein in their entirety by reference.

### BACKGROUND OF THE INVENTION

1. Field of the Invention

The present invention relates to a speech coding/decoding apparatus and method and more particularly, to a speech coding/decoding apparatus and method, in which a frame size, a quantizer structure, and a bit assignment method can be adjusted in accordance with characteristics of input speech signals so as to efficiently compress speech signal and also the frame size also can be adjusted in accordance with network conditions or codec type of a counter party.

2. Description of the Related Art

Conventionally, various coding methods for compressing and decompressing the digitalized speech signals were suggested and used. The waveform coding method such as pulse code modulation (PCM) and a hybrid coding method such as code-excited linear prediction (CELP) are widely used in various applications. The CELP type coder has been a main stream in the international telecommunication union-telecommunication standardization sector (ITU-T), in which waveform coding and parametric coding method is combined.

In the hybrid coding method, in order to efficiently compress speech signals, the spectrum information representing a vocal tract transfer function and an excitation signals are extracted on the basis of production models of speech signals, and quantize by proper methods for each parameter and then transmitted to the receiver systems. As representative hybrid coding technologies, there are ITU-T G.723.1, ITU-T G.729, and an adaptive multi-rate (AMR) coding method which standardized by 3GPP for IMT-2000 systems.

ITU-T G.723.1 is standardized so as to compress multimedia signals with a small number of bits. And this coder compress 30 msec input speech at two bit rates of 5.3 and 6.3 kbit/s, and provides good toll quality of a wired network.

ITU-T G.729 divides the input speech in a 10 ms unit segment and compresses the divided input speech at a bit rate of 8 kbit/s, and provides good toll quality of a wired network. ITU-T G.729 and ITU-T G.723.1 are widely used in VoIP applications. In order to efficiently implement G.729 which requires a large amount of calculation, there has been widely used G.729A, in which the complexity is decreased while maintaining the frame size and the bit-compatibility of G.729.

In addition, AMR coders are standardized by 3GPP for next-generation speech communication. These coders includes an AMR narrowband (AMR-NB) coder for processing telephone-line band (narrowband) signals and an AMR wideband (AMR-WB) coder for processing wideband signals. Both coders analyze and code the input speech in every 20 ms frame.

In conventional CELP speech coders, the spectral envelope and excitation information are extracted and quantized based on the speech production model. However, since the conventional speech coders using the CELP algorithm utilize the same frame size regardless of characteristics of the input speech, thus speech quality and coding efficiency can be deterioration.

Specifically, when the frame size for parameter analysis is 10 ms as in G.729, it is suitable for modeling transition segments being rapidly changed, but it decreases the coding efficiency at stationary segments such as voiced sound.

On the contrary, the frame size of 30 ms used in G.723.1 is suitable for coding the voiced sound segments, but the transmission rate of the spectrum information is not sufficient in the transition segments, so that distortion of the spectrum information is increased in sub frames.

That is, the conventional speech coders using the fixed frame size, quantizer structure, and bit-assignment regardless of the characteristics of input speech have a problem that performance deviation is increased in accordance with the characteristics of input speech.

The conventional speech coders always operate with a fixed frame size regardless of the characteristics of input speech. For example, G.723.1 has a frame size of 30 msec, G.729 has a frame size of 10 msec, the AMR-NB coder has a frame size of 20 msec, and they always process the speech signals in the pre-determined fixed frame size.

Recently, voice-over-IP (VoIP) that speech data would be transmitted through IP networks was paid attention to more and more. In general, it is known that the end-to-end delay should be 150 msec or less at a telephone call to provide good service quality. If the delay is increased, echoes occur and the conversation could be uncomfortable. Since the end-to-end delay could be continuously changed during a telephone call in packet networks, it is difficult to maintain a constant delay. In order to provide good services quality, the delay should be 150 msec or less and this delay should be kept during a telephone call.

When the speech coder is different to a speech coder of counter part, the call could be performed through a transcodec. The call could not be performed in the packet networks if the speech coder is not matched with a counter part speech coder, but the telephone call between IP-network users and wireless-network subscribers, who use different speech coders, is supported by the transcodec.

Conventionally, in the field of code division multiple access (CDMA), speech coders such as enhanced variable rate coders (EVRC) and Qualcomm code excited linear prediction (QCELP) are widely used, and in the VoIP system, G.729 and G.723.1 are widely used. For example, if a user of an IP telephone employing G.723.1 wants to call a wireless-network subscriber employing EVRC, a transcodec is required to phone call.

The transcodec converts bit strings coded and transmitted with G.723.1 into bit strings which can be decoded with the EVRC and converts bit strings coded and transmitted with the EVRC into bit strings which can be decoded with G.723.1. The delay corresponding to the least common multiple of the frame sizes of both speech coders is basically required for transcoding the speech signals.

Therefore, in order to perform a telephone call between subscribers which has the G.723.1 and EVRC coders, the minimum 60 msec delay is required for transcoding the speech signals. The increase of delay can affect the service quality.

### SUMMARY OF THE INVENTION

The present invention provides a speech coding/decoding apparatus and method being capable of enhancing speech coding/decoding performance by adjusting a frame size, using an adaptive quantizer structure and adjusting a bits assigned to spectral envelope and excitation signal in accordance with the characteristics of input speech.

The present invention also provides a speech coding/decoding apparatus and method being capable of enhancing service quality by adjusting the total delay required for transmitting speech data or adjusting the delay required for transcoding the speech data through adjustment of a frame size of a speech coder and the number of frames per packet in accordance with network conditions or speech codec type of a counter part in a packet network.

The present invention also provides a speech coding/decoding apparatus and method in which a frame size for packet transmission and a frame size for packet encoding are different each other.

According to an aspect of the present invention, there is provided a speech coding apparatus comprising: an input speech classification unit classifying the input speech into a transition segment and a stationary segment; a variable rate speech coding unit variably coding the input speech using frame sizes, quantizer structures, and bit assignment methods corresponding to the determined classes; and a multiplexing unit outputting bit strings for the input speech, which has been compressed in a variable frame size.

According to another aspect of the present invention, there is provided a speech coding method comprising: (a) dividing input speech into transition segment and a stationary segment; (b) variably coding the input speech using frame sizes, quantizer structures, and bit assignment methods corresponding to the divided classes; and (c) outputting bit strings of the coded input speech in a variable frame size.

According to another aspect of the present invention, there is provided a speech decoding apparatus comprising: a demultiplexing unit receiving bit strings coded using different frame sizes, quantizer structures, and bit assignment methods depending on the classes of input speech and extracting parameters for decoding from the bit strings; a variable rate speech decoding unit has decoding methods for every class parameter decoding, the variable rate speech decoding unit decoding the parameters in accordance with the received classes information; and a temporary storage unit temporarily storing the decoded input speech to continuously output the decoded speech signal.

According to another aspect of the present invention, there is provided a speech decoding method comprising: (a) receiving bit strings coded using different frame sizes, quantizer structures, and bit assignment methods in accordance with the classes information and extracting parameters for reconstruct the speech signal from the bit strings; (b) variably decoding the received parameters in accordance with the received classes information; and (c) temporarily storing the decoded speech to continuously output the signal.

According to another aspect of the present invention, there is provided a speech coding apparatus comprising: a frame determining unit determining frame sizes and the number of frames per packet for transmission of input speech on the basis of delay information of a network or information on kinds of a counter-party speech coder; a variable-rate speech coding unit variably coding the input speech in accordance with the frame sizes and the number of frames determined; and a multiplexing unit outputting bit strings of the input speech coded in a variable frame size.

According to another aspect of the present invention, there is provided a speech coding method comprising: (a) determining frame sizes and the number of frames per packet on the basis of network delay information or speech codec type of a counter part; (b) variably coding the speech signals in accordance with the frame sizes and the number of frames having been determined; and (c) outputting bit strings of the speech signals coded in a variable frame size.

According to another aspect of the present invention, there is provided a speech decoding apparatus comprising: a demultiplexing unit receiving bit strings of speech signals coded on the basis of network delay information and extracting coding parameters for decoding from the bit strings; variable speech decoding units provided every frame size, each variable speech decoding unit variably decoding the received parameters in accordance with the frame sizes of the received parameters; and a temporary storage unit temporarily storing the decoded speech signals to continuously output the signals.

According to another aspect of the present invention, there is provided a speech decoding method comprising: (a) receiving bit strings of speech signals coded on the basis of network delay information and extracting the parameters for decoding from the bit strings; (b) variably decoding the received parameters in accordance with the frame sizes of the received parameters in every frame size; and (c) temporarily storing the decoded speech signals to continuously output the decoded speech signals.

According to another aspect of the present invention, there is provided a speech coding apparatus comprising: a variable coding unit determining frame sizes for coding on the basis of any one of a characteristic of input speech, network delay information, and codec type of a counter party, and coding the input speech on the basis of the determined frame size; and a frame transmitting unit transmitting the coded frames at a constant transmission interval.

According to another aspect of the present invention, there is provided a speech coding method comprising: determining frame sizes for coding on the basis of a characteristic of input speech, network delay information, and codec type of a counter part, and coding the input speech on the basis of the determined frame sizes; and transmitting the coded parameters at a constant transmission interval.

As a result, by optimally adjusting the frame size, the quantizer structure, and the bit assignment method in accordance with characteristics of the input speech and adjusting the frame size in accordance with speech codec type of a counter part, it is possible to improve the performance of the speech coding/decoding apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a structure of an embodiment of a speech coding apparatus and a speech decoding apparatus based on the present invention, which can optimally code and decode the input speech in accordance with characteristics of input speech signals;

FIG. 2 is a diagram illustrating an example of input speech classification by speech classification unit according to the present invention, which can optimally compress the input speech in accordance with characteristics of input speech signals;

FIG. 3 is a block diagram illustrating a structure of a variable rate speech coding unit of the speech coding apparatus according to the present invention, which can optimally code the speech signal in accordance with characteristics of input speech signals;

FIG. 4 is a block diagram illustrating a structure of a variable rate speech decoding unit of the speech decoding apparatus according to the present invention, which can optimally decode the parameters in accordance with the received class information;

FIGS. 5A and 5B are flowcharts illustrating flows of a speech coding method and a speech decoding method according to the present invention, which can optimally code and decode the input speech in accordance with characteristics of input speech signals;

FIG. 6 is a block diagram illustrating a structure of an embodiment of a speech coding/decoding apparatus according to the present invention, which can reduce the delay required for a telephone call based on the network conditions;

FIGS. 7A and 7B are flowcharts illustrating flows of an embodiment of a speech coding method and a speech decoding method according to the present invention, which can reduce the delay required for a telephone call based on the network condition;

FIG. 8 is a block diagram illustrating a structure of an embodiment of a speech coding/decoding apparatus according to the present invention, which can adjust a frame size in accordance with codec type of a counter part;

FIGS. 9A and 9B are flowcharts illustrating flows of an embodiment of a speech coding/decoding method according to the present invention, which can adjust a frame size in accordance with codec types of a counter part;

FIG. 10A is a block diagram illustrating a structure of an embodiment of the speech coding/decoding apparatus which have variable analysis frame size and constant transmission interval;

FIG. 10B is a flowchart illustrating a flow of an embodiment of the speech coding method with a variable analysis frame size and a constant transmission interval; and

FIG. 11 is a diagram illustrating various frame types according to the present invention.

### DETAILED DESCRIPTION OF THE INVENTION

Hereinafter, a speech coding/decoding apparatus and method according to the present invention will be described in details with reference to the attached drawings.

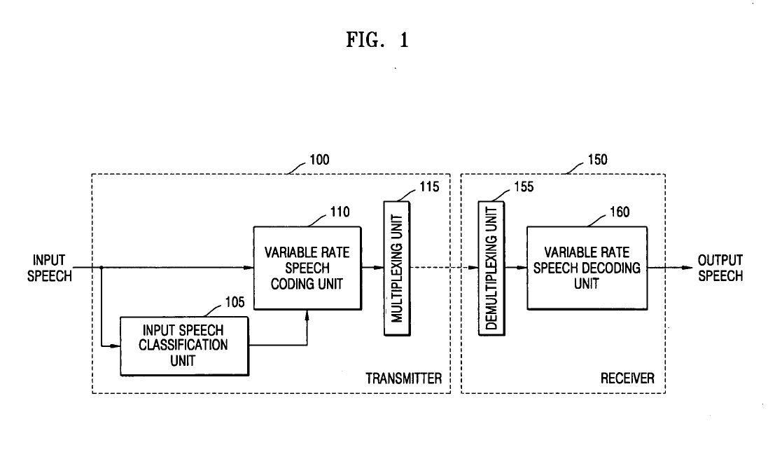

FIG. 1 is a block diagram illustrating a structure of a speech coding apparatus and a speech decoding apparatus according to an embodiment of the present invention, which can optimally code the input speech according to the characteristics of input speech signals and decode the parameters according to the received class information.

FIG. 1 shows a simplified speech communication system, where the speech coding apparatus used as a transmitter 100 and the speech decoding apparatus (150) used as a receiver 150.

The speech coding apparatus as the transmitter 100 are comprised of an input speech classification unit 105, a variable rate speech coding unit 110, and a multiplexing unit 115. The speech decoding apparatus as the receiver 150 are comprised of a demultiplexing unit 155 and a variable rate speech decoding unit 160.

The input speech classification unit 105 determines the classes of input speech. The input speech is classified into a transition segment where speech signals are rapidly varied with time and a stationary segment such as a voiced sound segment where speech signals are relatively slowly changed with time. Since transition segment and stationary segment have different characteristics. G.729 is more efficient for coding of transition segment and G.723.1 is more suitable for coding of stationary segment. In this way, since the optimum coding methods are different depending on the input speech class, the input speech classification unit 105 classifies the input speech to select the optimum coding method. The input speech classification unit 105 can classify the input speech into various classes in accordance with the characteristics of the input speech, in addition to the transition segment and the stationary segment.

The input speech classification unit 105 can operate based on an open loop classification method and a closed loop classification method to classify the input speech. The class of the input speech is determined directly in accordance with the characteristics thereof in the open loop classification method, while the class of the input speech is determined through a feedback procedure in the closed loop classification method.

The variable rate speech coding unit 110 codes the input speech using a frame size, a quantizer structure, and a bit assignment method which are predetermined in accordance with the class determined by the input speech classification unit 105.

The multiplexing unit 110 outputs the bit strings of coding parameters from the variable rate speech coding unit 110, considering that the variable rate speech coding unit 110 uses a variable frame size.

The demultiplexing unit 155 of the receiver 150 receives the bit strings from the multiplexing unit 115 of the transmitter 100 and extracts parameter information required for the decoding from the received bit strings. The demultiplexing unit 155 transfers the extracted parameters to the variable rate speech decoding unit 160 to decode the parameters according to the class information.

The variable rate speech decoding unit 160 decodes the parameter with a different frame sized and quantizer structure determined by the class information.

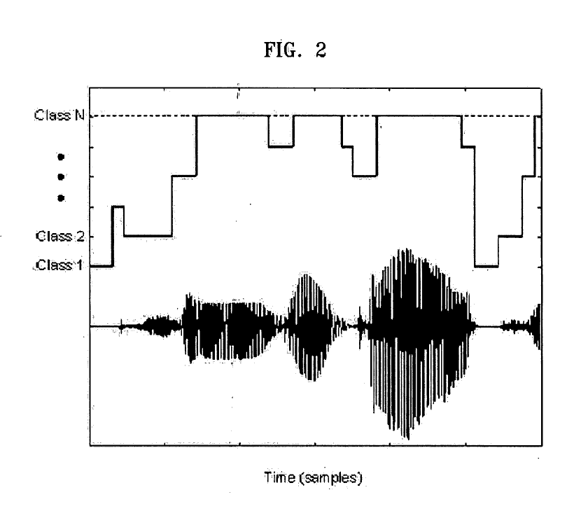

FIG. 2 shows an example of input speech class determination by the input speech classification unit according to the present invention, which can optimally code the input speech in accordance with characteristics of the input speech signals.

The speech signals have various characteristics and the input speech classification unit determines the class of input speech. Different coding methods are applied in accordance with the class determined by the input speech classification unit 105.

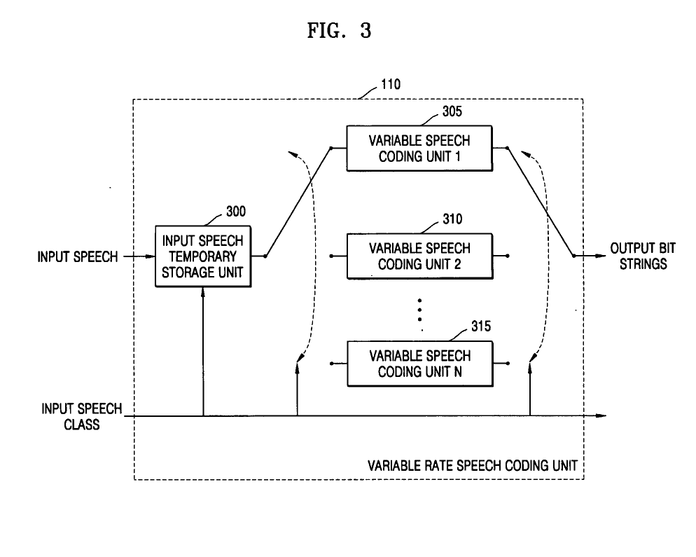

FIG. 3 is a block diagram illustrating a structure of a variable rate speech coding unit of the speech coding apparatus according to the present invention, which can optimally compress the input speech in accordance with characteristics of the input speech signals.

As shown in FIG. 3, the variable rate speech coding unit 110 is comprised of an input speech temporary storage unit 300 and at least one variable speech coding units 305 to 315. The input speech signals stored in the input speech temporary storage unit 300 are transmitted to one of the variable speech coding unit 305 to 315 corresponding to the classes of the input speech.

The variable speech coding units 305 to 315 correspond to the classes determined by the input speech classification unit 105.

For example, it is supposed that the input speech classification unit 105 divides the input speech into several classes such as transition segment and stationary segment. Then, one of the variable speech coding units 305 to 315 is selected for input signal compression based on the class information determined by input speech classification unit 105. The input speech classification unit 105 determines whether the input speech belongs to the transition segment or the stationary segment and transmits the input speech to the one of the variable speech coding unit among several variable speech coding units 305 to 315.

The variable speech coding units 305 to 315 have different frame sizes, quantizer structures, and bit assignment methods. Therefore, the variable rate speech coding unit 110 can code the input speech using an optimum coding methods corresponding to the each classes.

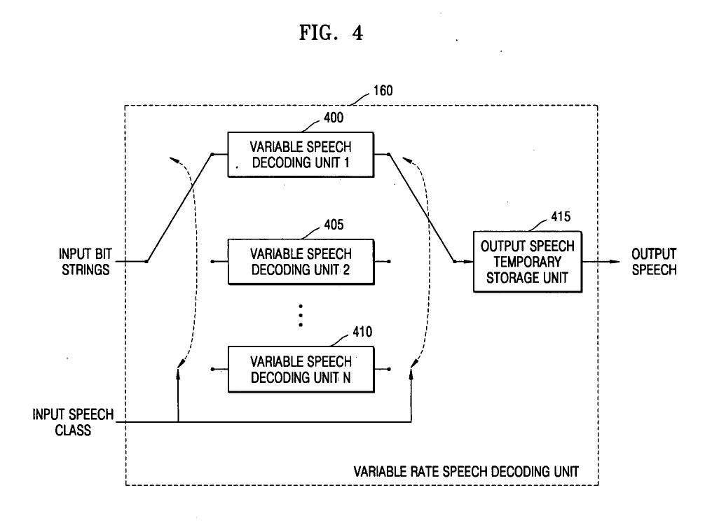

FIG. 4 is a block diagram illustrating a structure of the variable rate speech decoding unit of the speech decoding apparatus according to the present invention, which can optimally decode the received parameters in accordance with the class information.

As shown in FIG. 4, the variable rate speech decoding unit 160 is comprised of several variable speech decoding units 400 to 410 and an output speech temporary storage unit 415.

When the demultiplexing unit 155 of the receiver 150 receives the bit strings, the demultiplexing unit 155 transmits the received bit strings to the one of the variable speech decoding unit which selected by the class information among several variable speech decoding units 400 to 410.

The variable speech decoding units 400 to 410 decode the received parameters in accordance with the class information. The variable speech decoding units 400 to 410 of the receiver 150 and the variable speech coding units 305 to 315 of the transmitter 100 correspond to each other and perform the coding and decoding in accordance with the class of the input speech, respectively.

The output speech temporary storage unit 415 temporarily stores and outputs the speech signal decoded by the variable speech decoding units 400 to 410 to enable the continuous speech output. That is, since the frame size of the speech decoded by the respective variable speech decoding units 400 to 410 is variable, the output speech temporary storage unit 415 temporarily stores the decoded speech and then outputs the decoded speech continuously.

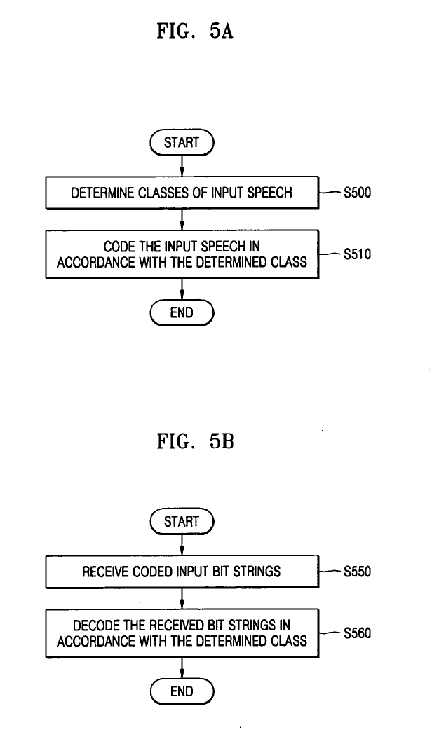

FIGS. 5A and 5B are flowcharts illustrating flows of a speech coding and decoding method according to the present invention, which can optimally code and decode the input speech in accordance with characteristics of input speech signals.

Referring to FIG. 5A, the input speech classification unit 105 determines the class of input speech based on the characteristics of input speech (S500).

The variable rate speech coding unit 110 codes the input speech using the frame sizes, the quantizer structures, and the bit assignment methods corresponding to the class of input speech, and outputs the parameters (S510).

Referring to FIG. 5B, the demultimplexing unit 155 receives the bit strings and transmits the received bit strings to one of the variable speech decoding unit 400 to 410 based on the class information.

The variable speech decoding units 400 to 410 decode the received bit strings and output the speech signal continuously.

FIGS. 1 to 5B illustrate the structure of the speech coder/decoder of which the frame sizes and the bit assignment methods are adaptively changed according to the characteristics of the input speech, and more particularly, illustrates the speech coding/decoding apparatus and method in which the frame sizes can be changed during a telephone call.

In the speech coding/decoding apparatus and method according to the present invention, the delay occurring when the frame sizes of speech codec are different between both users can reduced by setting the frame sizes with the frame size of speech coder used in counter part during call setup as well as during a telephone call.

For example, in a case where A calls B, when the frame size of the speech coder of B is 20 msec, A sets the frame size of its speech coder to 20 msec, and when the frame size of the speech coder of B is 10 msec, A sets the frame size of its speech coder to 10 msec.

In this way, when the frame sizes of the speech coders of A and B become to equal, there is a merit in the tandem delay. When the frame size of the speech coder of A is 20 msec and the frame size of the speech coder of B is 30 msec, a minimum 60 msec delay is required for the telephone call between A and B. However, if the frame size of A is set to 30 msec, only 30 msec delay is required for the telephone call.

Therefore, by employing the speech coder having a structure where the frame size can be set to the same frame size with the frame size of the counter part speech coder, it is advantageous in view of the tandem delay.

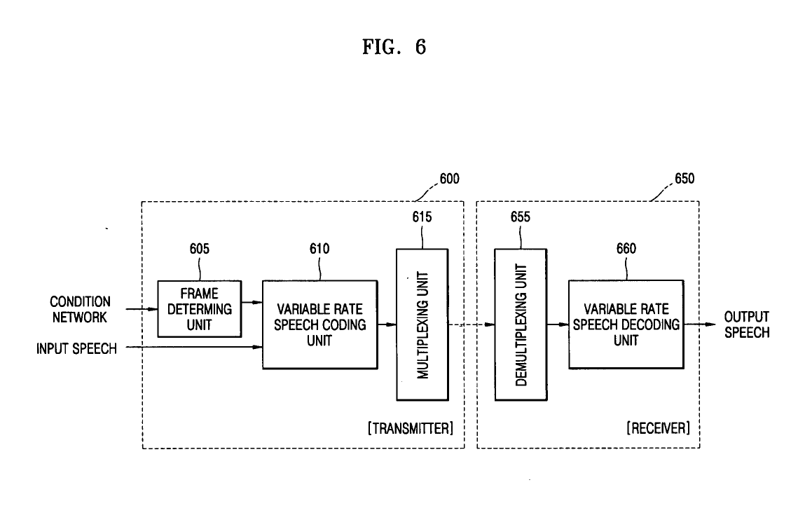

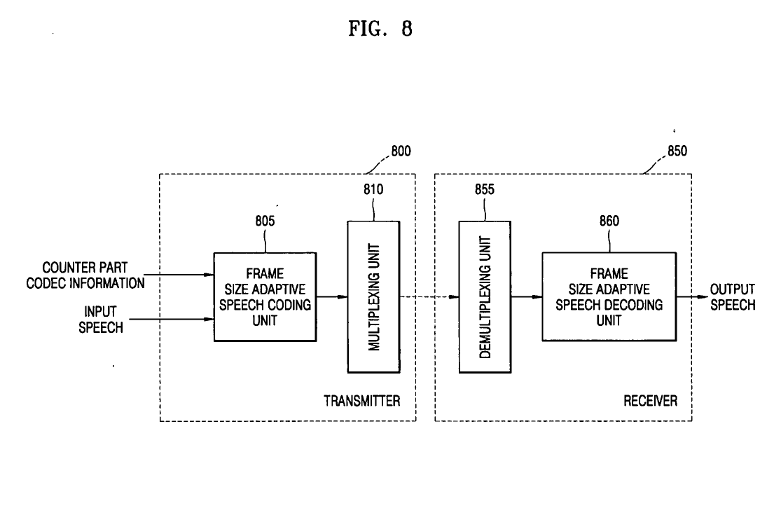

Now, a speech coding/decoding apparatus and method in which the delay reduction method for telephone call will be described in detail with reference to FIGS. 6 and 9.

FIG. 6 is a block diagram illustrating a structure of an embodiment of the speech coding/decoding apparatus according to the present invention, which can reduce the delay required for a telephone call.

FIG. 6 shows a speech communication system, where speech coding apparatus used as a transmitter 600 and speech decoding apparatus used as a receiver 650.

The speech coding apparatus as the transmitter 600 is comprised of a frame determination unit 605, a variable rate speech coding unit 610, and a multimplexing unit 615. The speech decoding apparatus as the receiver 650 is comprised of a demultiplexing unit 655 and a variable rate speech decoding unit 660.

The frame determination unit 605 determines the frame sizes and the number of frames per packet for speech coding. The frame sizes and the number of frames per packet are determined on the basis of a network conditions. For example, if the total end-to-end delay of the network is increase then deterioration of service quality can occur. The total end-to-ed delay can be decreased by reducing the frame sizes and the number of frames per packet of the speech coding apparatus. When the total network delay is decreased, the frame sizes and the number of frames per packet are increased.

Since the total delay can be changed during a telephone call, the total delay could be maintained at a constant level by continuously adjusting the frame sizes and the number of frames per packet according to the network conditions during the telephone call.

The variable rate speech coding unit 610 compresses the input speech signals with a frame sizes determined by the frame determination unit 605. Since the frame sizes can be changed during a telephone call, the variable rate speech coding unit 610 adjusts the change of the frame sizes during the telephone call, thereby preventing the quality deterioration.

The multiplexing unit 615 outputs the bit strings of the coding parameters of the variable rate speech coding unit 610, by considering that the variable rate speech coding unit 610 uses a variable frame size.

The frame determination unit 605 and the input speech classification unit 105 shown in FIG. 1 may be realized as a body, which can determine the classes of the input speech and the frame size. The variable rate speech coding unit 610 can be constructed to have the same function and structure as the variable rate speech coding unit shown in FIG. 1. However, the variable rate speech coding unit 110 of FIG. 1 performs the coding in accordance with the classes of the input speech, and the variable rate speech coding unit 610 of FIG. 6 performs the coding in accordance with the frame sizes. The multiplexing unit 615 can be constructed to have the same function and structure as the multiplexing unit 115 of FIG. 1.

Therefore, the speech coding apparatus 600 shown in FIG. 6 can be embodied using the speech coding apparatus 100 according to the present invention shown in FIG. 1, and the respective functions of the speech coding apparatuses 100 and 600 shown in FIGS. 1 and 6 may be embodied by one coding apparatus.

The demultiplexing unit 655 of the receiver 650 receives the bit strings output of the multiplexing unit 615 of the transmitter 600. The demultiplexing unit 655 extracts parameters required for the decoding from the received bit strings and transmits the extracted bit strings to the variable rate speech decoding unit 660. The variable rate speech decoding unit 660 decodes the received bit strings. A temporary storage unit (not shown) temporarily stores the decoded speech signal and continuously outputs the decoded speech signal.

The receiver 650 of FIG. 6 can be embodied using the receiver 150 shown in FIG. 1 and vice versa. The functions of the receivers 150 and 650 can be embodied by one receiver.

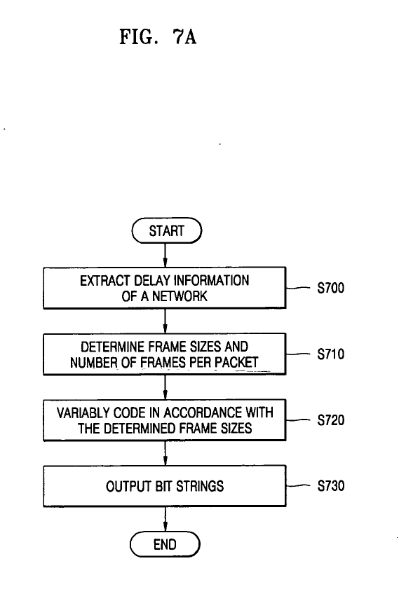

FIGS. 7A and 7B are flowcharts illustrating a flow of an embodiment of the speech coding/decoding method according to the present invention, which can reduce the delay required for a telephone call.

Referring to FIG. 7A, the frame determination unit 605 determines the frame sizes and the number of frames per packet based on the network delay (S700, S710). The variable rate speech coding unit 610 codes the input speech signals using the determined frame sizes and outputs the coded speech signals (S720, S730).

Referring to FIG. 7B, the demultiplexing unit 655 receives the bit strings of the coded input speech (S750), extracts parameters required for the decoding from the received bit strings, and transmits the received bit strings to the variable rate speech decoding unit 660 (S750). The variable rate speech decoding unit 660 variably decodes the bit strings in accordance with the frame sizes of the received input speech and outputs the decoded input speech (S760). The temporary storage unit (not shown) temporarily stores the decoded speech to continuously output the decoded speech.

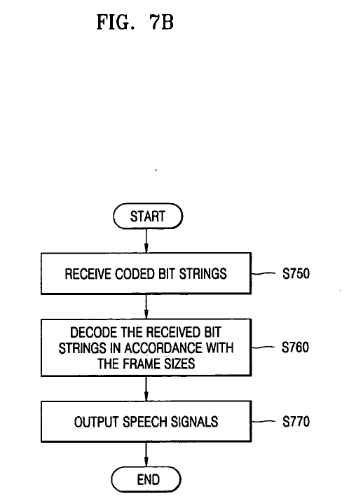

FIG. 8 is a block diagram illustrating a structure of an embodiment of the speech coding/decoding apparatus which can adjust the frame size in accordance with speech codec type of a counter part.

Referring to FIG. 8, the speech coding apparatus as a transmitter 800 is comprised of a frame size adaptive speech coding unit 805 and a multiplexing unit 810. The speech decoding apparatus as a receiver 850 is comprised of a demultiplexing unit 855 and a frame size adaptive speech decoding unit 860.

A transcodec is necessary for a telephone call between users having different speech codec. In this case, by adjusting the frames size of the speech coder, the delay required for transcoding can be decreased. In other words, the transcodec is necessary for a telephone call between a user of an IP telephone and a wireless network subscriber, which use different speech codec. The delay corresponding to the least common multiple of the frame sizes of the coders used in both parties is necessary for the transcoding except the delay required for transcoding computation.

For example, when the transcoding is used for a telephone call between users having G.723.1 and EVRC, respectively, the minimum delay for transcoding is 60 msec. Therefore, in a case where the transcoding is required, when the frame sizes of the speech coders are equal each other, the delay required for the transcoding is reduced. As a result, by adjusting the frame size of the speech coder to be equal to the frame size of the counter part speech coder, the delay required for the transcoding can be reduced.

The frame size adaptive speech coding unit 805 codes the input speech signals with the frame size determined in accordance with speech codec type of the counter part. The frame size is determined in accordance with the codec types of the counter part at the time of call setup and is not changed during the telephone call. The multiplexing unit 810 outputs the bit strings of the input speech coded by the frame size adaptive speech coding unit 805.

The demultiplexing unit 855 of the receiver 850 receives the bit strings output from the multiplexing unit 810 of the transmitter 800. Then, the demultiplexing unit 855 extracts parameters required for the decoding from the received bit strings and transmits the received bit strings to the frame size adaptive speech decoding unit 860. When the frame size is determined, the frame size adaptive speech coding and decoding apparatuses 800 and 850 code and decode the speech signals, respectively, using a speech signal analysis and a quantization table corresponding to the frame size.

FIGS. 9A and 9B are flowcharts illustrating a flow of an embodiment of the speech coding/decoding method which can adjust the frame size in accordance with the speech codec type of the counter part.

Referring to FIG. 9A, the frame size adaptive speech coding unit 805 codes the speech signals with the frame size determined in accordance with the codec type of the counter part using the transcoding (S900, S910). The multiplexing unit 810 outputs the bit strings of the input speech coded in the variable frame size (S920).

Referring to FIG. 9B, the demultiplexing unit 855 receives the bits strings of the coding parameters (S950), and transmits the received bit strings to the frame size adaptive speech decoding unit 860 of the speech decoding apparatus 850. The frame size adaptive speech decoding unit 860 decodes the received bit strings (S960), and a temporary storage unit (not shown) temporarily stores the decoded speech signal to continuously output the decoded speech (S970).

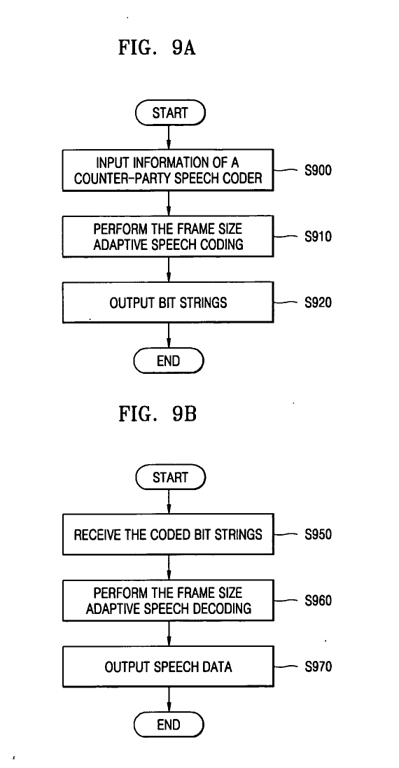

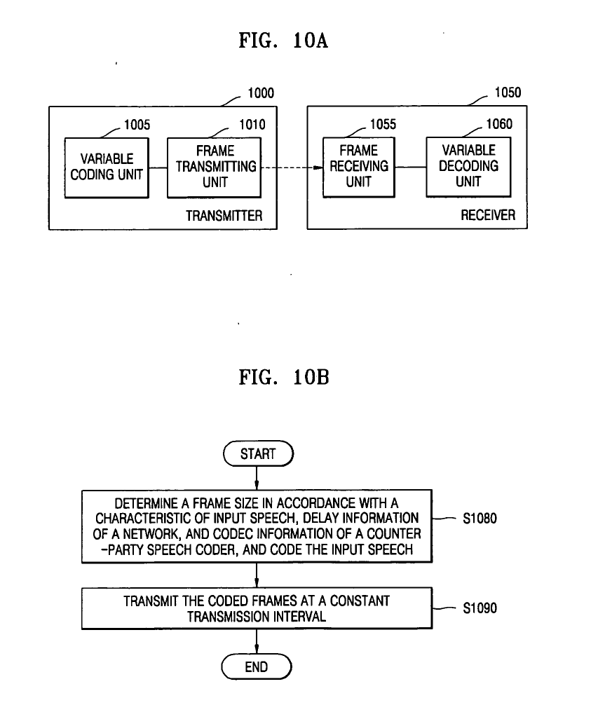

FIG. 10A is a block diagram illustrating a structure of an embodiment of the speech coding/decoding apparatus with a variable analysis frame size and a constant transmission interval.

Referring to FIG. 1A, the speech coding apparatus 1000 according to the present invention serves as a transmitter and is comprised of a variable coding unit 1005 and a frame transmitting unit 1010. The speech decoding apparatus 1050 serves as a receiver and is comprised of a frame receiving unit 1055 and a variable decoding unit 1060.

The variable coding unit 1005 determines the frame size in accordance with the characteristics of input speech and codes the input speech with the determined frame size.

The determination of the frame size in accordance with the characteristic of the input speech has been described with reference to FIG. 1.

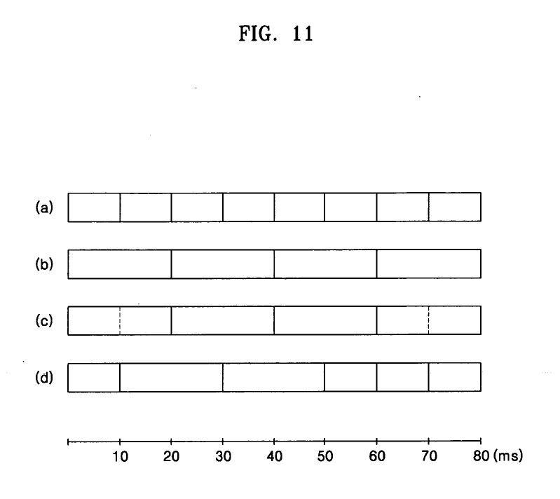

The variable coding unit 1005 codes the speech signals in various frame sizes corresponding to the characteristic of the input speech. The frame transmitting unit 1010 transmits the speech data, coded in various frame sizes and output from the variable coding unit 1005, at frame intervals, or at a constant transmission interval. This frame is shown in FIG. 11C.

The speech decoding apparatus 1050 performs the inverted procedure of the speech coding apparatus 1000. That is, the frame receiving unit 1055 receives the frames transmitted at a non-uniform interval or the frames transmitted at a constant interval, and the variable decoding unit 1060 decodes the input speech in accordance with the received frame size.

The principle of the speech coding/decoding apparatus according to the present invention shown in FIG. 10A can be applied to the apparatuses shown in FIGS. 1, 6, and 8.

FIG. 10B is a flowchart illustrating a flow of an embodiment of the speech coding method with a variable frame size and a constant transmission interval.

Referring to FIG. 10B, the variable decoding unit 1005 determines the frame size in accordance with the characteristic of the input speech, the network delay, and the speech codec type of the counter part, and codes the input speech on the basis of the determined frame size (S1080).

The frame transmitting unit 1010 transmits the frames coded in various sizes by the variable coding unit 1005 at a constant transmission interval (S1090).

FIG. 11 is a diagram illustrating various frame types according to the present invention.

FIGS. 11(a) and (b) show the frame structure, where the input speech is coded and transmitted at a constant interval. For example, the frame size of FIG. 11(a) is 10 msec. That is, the speech coding apparatus codes the input speech signals in a unit of 10 msec and transmits the coding parameters every 10 msec. FIG. 11(b) shows a conventional speech coding apparatus in which the frame size is 20 msec, the input speech signals are coded every 20 msec and the coding parameters are transmitted every 20 msec.

FIG. 11(c) explains the features of the embodiments shown in FIGS. 10A and 10B, where the transmission interval is indicated by a solid line and the analysis frame size is indicated by a dotted line. Referring to FIG. 11(c), the speech coding apparatus process the speech signals every 10 msec or 20 msec in accordance with the characteristic of the input speech signals, but the coding parameters are transmitted every 20 msec. That is, the frame size for analyzing the input speech signals is determined in accordance with the characteristic of the input speech signals, but the coding parameters are transmitted at a constant interval.

FIG. 11(d) illustrates features of the present invention shown in FIGS. 1 to 9B and specifically illustrates the frame in which the speech signals are coded in a unit of 10 ms or 20 ms in accordance with characteristics of the input speech and the transmission interval is varied in accordance with the analysis frame size.

According to the present invention, since the frame size, the quantizer structure, and the bit assignment can be optimally adjusted in accordance with the characteristic of input speech, it is possible to enhance the performance of the speech coding apparatus.

Further, by adjusting the frame size of the speech coder in accordance with the network condition or speech codec type of a counter part, the delay required for transmitting speech data can be adaptively controlled, so that it is possible to enhance the speech service quality.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A speech coding apparatus comprising:
an input speech classification unit classify the input speech into several class such as a transition segment and a stationary segment;
a variable rate speech coding unit coding the input speech using a frame sizes, quantizer structures, and bit assignment methods determined by the class information; and
a multiplexing unit outputting a bit string of coding parameters, which has been extracted in the variable frame size.

2. The speech coding apparatus according to claim 1, wherein the input speech classification unit determines the classes of the input speech using an open loop class determination method or a closed loop class determination method.

3. The speech coding apparatus according to claim 1, wherein the variable rate speech coding unit comprises:
an input speech temporary storage unit storing an input speech signal every frame size corresponding to the determined class; and
variable speech coding unit has various coding structure to process the every class signal, the variable speech coding unit coding the input speech signal using the frame sizes, the quantizer structures, and the bit assignment methods corresponding to the determined classes.

4. A speech coding method comprising:
(a) classify the input speech into a several class such as transition segment and a stationary segment;
(b) variably coding the input speech using different frame sizes, quantizer structures, and bit assignment methods in accordance with the determined classes; and
(c) output the bit strings of the coding parameter which extracted in a variable frame size.

5. A speech decoding apparatus comprising:
a demultiplexing unit receiving bit strings coded with frame sizes, quantizer structures, and bit assignment methods corresponding to the input speech class and extracting parameters for decoding from the bit strings;
a variable rate speech decoding unit has information for every class, the variable rate speech decoding unit reconstruct the speech signal in accordance with the classes information for received bit strings; and
a temporary storage unit temporarily storing the decoded speech to continuously output the reconstructed speech.

6. A speech decoding method comprising:
(a) receiving bit strings coded using frame sizes, quantizer structures, and bit assignment methods in accordance with input speech class and extracting parameter information necessary for decoding from the bit strings;
(b) variably decoding the received parameters in accordance with the classes of the received parameters; and
(c) temporarily storing the decoded speech to continuously output the reconstructed speech.

7. A speech coding apparatus comprising:
a frame determining unit determining the frame sizes and the number of frames per packet for transmission of input speech on the basis of a network delay or codec type of a counter part;
a variable rate speech coding unit variably coding the input speech in accordance with the frame sizes and the number of frames determined; and
a multiplexing unit outputting bit strings of the coding parameters extracted in a variable frame size.

8. The speech coding apparatus according to claim 7, wherein the frame determination unit decreases the frame sizes and the number of frames when the network delay is increased, and increases the frame size and the number of frames when the network delay is decreased.

9. The speech coding apparatus according to claim 7, wherein the frame determination unit sets the frame sizes of the speech coder with the frame size of the counter party speech coder.

10. The speech coding apparatus according to claim 7, wherein the frame determination unit determines the frame sizes and the number of frames on the basis of the network delay, which is changed during a telephone call.

11. The speech coding apparatus according to claim 7, wherein the frame determination unit determines the frame sizes and the number of frames on the basis of the type of counter party speech coder acquired at the call setup procedure.

12. The speech coding apparatus according to claim 7, wherein the variable rate speech coding unit comprises:
an input speech temporary storage unit storing input speech samples corresponding to the determined frame sizes; and
variable speech coding units provided every frame size, wherein the variable speech coding unit corresponding to the determined frame sizes code the input speech samples.

13. A speech coding method comprising:
(a) determining frame sizes and the number of frames per packet for coding speech signals on the basis of network delay information or codec type of a counter part;
(b) coding the speech signals in accordance with the frame sizes and the number of frames having been determined; and
(c) outputting bit strings of the speech signals coded in a variable frame size.

14. A speech decoding apparatus comprising:
a demultiplexing unit receiving bit strings for speech signals coded on the basis of network delay information and extracting parameters necessary for reconstruct the speech signal from the bit strings;
variable speech decoding units have the every information for decoding the received parameters, each variable speech decoding unit variably decoding the received speech signals in accordance with the frame sizes of the received speech signals; and
a temporary storage unit temporarily storing the decoded speech signals to continuously output the decoded speech signals.

15. A speech decoding method comprising:
(a) receiving bit strings of speech signals coded on the basis of network delay information and extracting parameter information necessary for decoding from the bit strings;
(b) variably decoding the received coding parameters in accordance with the frame sizes of the received signals; and
(c) temporarily storing the decoded speech signals to continuously output the decoded speech signals.

16. A speech coding apparatus comprising:
a variable coding unit determining frame sizes for coding on the basis of any one of a characteristic of input speech, network delay information, and speech codec type of a counter part, and coding the input speech on the basis of the determined frame size; and
a frame transmitting unit transmitting the coded frames at a constant transmission interval.

17. The speech coding apparatus according to claim 16, wherein the variable coding unit divides input speech into a transition segment and a stationary segment and optimally coding the input speech in accordance with speech characteristics of the respective segments.

18. The speech coding apparatus according to claim 16, wherein the variable coding unit decreases the frame sizes when the network delay is increased, and increases the frame sizes when the network delay is decreased.

19. The speech coding apparatus according to claim 16, wherein the variable coding unit codes the input speech in the same frame size as the frame size of the counter party coder.

20. A speech coding method comprising:
determining frame sizes for coding on the basis of any one of a characteristic of input speech, network delay information, and speech codec type of a counter part, and coding the input speech on the basis of the determined frame sizes; and
transmitting the coded parameters at a constant transmission interval.
